(19) United States
(12) Patent Application Publication
(10) Pub. No.: US 2015/0249410 A1
(43) Pub. Date: Sep. 3, 2015

(54) Control Device and Control Method for Brushless Motor

(71) Applicant: Hitachi Automotive Systems, Ltd., Hitachinaka-shi, Ibaraki (JP)

(72) Inventor: Masaki Hano, Isesaki-shi (JP)

(21) Appl. No.: 14/427,413

(22) PCT Filed: Mar. 13, 2014
(86) PCT No.: PCT/JP2014/056790

§ 371 Date: Mar. 11, 2015

(30) Foreign Application Priority Data
Apr. 23, 2013 (JP) 2013-090687

(51) Int. Cl. H02P 6/20

(52) U.S. Cl. CPC H02P 6/20

(57) ABSTRACT

In a positioning control performed in an event of starting a low-speed sensorless control, a positioning energization mode of energizing two phases among three phases of a brushless motor and maintaining this energization is implemented. When a predetermined time has elapsed from the implementation of the positioning energization mode, a variation α of a non-energized phase voltage in the positioning energization mode is computed so as to estimate an operation direction of a rotor, and a switching flag Fmod of an energization mode is set based on whether this variation a is positive or negative. Then, in response to a value of the switching flag Fmod, the energization mode is temporarily switched to other energization mode so as to generate torque for the rotor in a direction reverse to the operation direction thereof, and a “brake” is applied, resulting in a shortened time required to position the rotor.

### TECHNICAL FIELD

The present invention relates to a control device and a control method for a brushless motor.

### BACKGROUND ART

As a control device and a control method for a brushless motor, those are known, which energize a predetermined phase of the brushless motor and position a rotor thereof to a predetermined position in a case of starting a sensorless control (for example, refer to Patent Document 1).

### REFERENCE DOCUMENT LIST

### Patent Document

Patent Document 1: Japanese Patent Application Laid-open Publication No. 2012-060741

### SUMMARY OF THE INVENTION

### Problems to be Solved by the Invention

However, as inertia of a body of rotation, such as a pump driven by the brushless motor, and of the rotor itself is becoming larger, a swing of the rotor with respect to a predetermined position becomes less likely to be attenuated. Hence, it takes long to position the rotor to the predetermined position, and accordingly, it is apprehended that the start of the sensorless control may be delayed, and that starting responsiveness of the pump and the like may be lowered.

In this connection, in consideration of the conventional problem as described above, it is an object of the present invention to provide a control device and a control method for a brushless motor, which are capable of shortening such a time required to position the rotor in the case of starting the sensorless control.

### Means for Solving the Problems

Therefore, a control device and a control method for a brushless motor according to the present invention are those which maintain energization to predetermined phases of the brushless motor and position a rotor to a predetermined position in a case of having received a start command of the brushless motor, and the control device and the control method temporarily switch an energization mode to other energization mode of energizing phases of a combination different from that of the predetermined phases.

### Effects of the Invention

According to the control device and the control method for the brushless motor according to the present invention, the time required to position the rotor can be shortened in the case of starting the sensorless control.

### BRIEF DESCRIPTION OF THE DRAWINGS

FIG. 1 is a configuration diagram illustrating a cooling system that cools an engine.

FIG. 2 is a circuit diagram illustrating configurations of a brushless motor and a control device therefor.

FIG. 3 is a timing diagram illustrating energization modes of the brushless motor.

FIG. 4 is a flowchart illustrating a content of control processing for the brushless motor.

FIG. 5 is a flowchart illustrating a content of positioning control processing for a rotor.

FIG. 6A to FIG. 6F illustrate positioning angles by respective energization mode: FIG. 6A is an explanatory view for an energization mode (1); FIG. 6B is an explanatory view for an energization mode (2); FIG. 6C is an explanatory view for an energization mode (3); FIG. 6D is an explanatory view for an energization mode (4); FIG. 6E is an explanatory view for an energization mode (5); and FIG. 6F is an explanatory view for an energization mode (6).

FIG. 7 is an explanatory view explaining a forward torque generated by a positioning energization mode.

FIG. 8A to FIG. 8C illustrate waveform charts of non-energized phase voltages with respect to a rotor magnetic pole phase: FIG. 8A is an explanatory view for the energization mode (2); FIG. 8B is an explanatory view for the energization mode (3); and FIG. 8C is an explanatory view for the energization mode (4).

FIG. 9 is an explanatory view explaining a reverse torque generated by switching of the energization modes.

FIG. 10 is an explanatory view illustrating a non-energized phase voltage in a state of FIG. 7.

FIG. 11 is a flowchart illustrating a content of reverse switching processing for the energization mode.

FIG. 12A and FIG. 12B explain changes of the non-energized phase voltage, which follow the switching of the energization modes: FIG. 12A is a waveform chart of the non-energized phase voltage with respect to the rotor magnetic pole phase in the energization mode (3); and FIG. 12B is a waveform chart of the non-energized phase voltage with respect to the rotor magnetic pole phase in the energization mode (2).

FIG. 13A and FIG. 13B explain a change of the non-energized phase voltage, which follows the switching of the energization modes: FIG. 13A is a waveform chart of the non-energized phase voltage with respect to a time; and FIG. 13B is a timing diagram of the energization modes.

FIG. 14A to 14C are waveform charts explaining timing of returning the energization modes to the positioning energization mode: FIG. 14A is a waveform chart of the non-energized phase voltage with respect to the rotor magnetic pole phase in the energization mode (3); FIG. 14B is a waveform chart of the non-energized phase voltage with respect to the rotor magnetic pole phase in the energization mode (2); and FIG. 14C is a waveform chart of the non-energized phase voltage with respect to the time.

FIG. 15 is a flowchart illustrating a content of forward switching processing for the energization mode.

FIG. 16A and FIG. 16B explain an applied voltage in a “brake” energization mode: FIG. 16A is a waveform chart of the non-energized phase voltage to the time in the positioning energization mode: and FIG. 16B is a graph showing ratios of respective peak values with respect to an initial peak in FIG. 16A.

### MODE FOR CARRYING OUT THE INVENTION

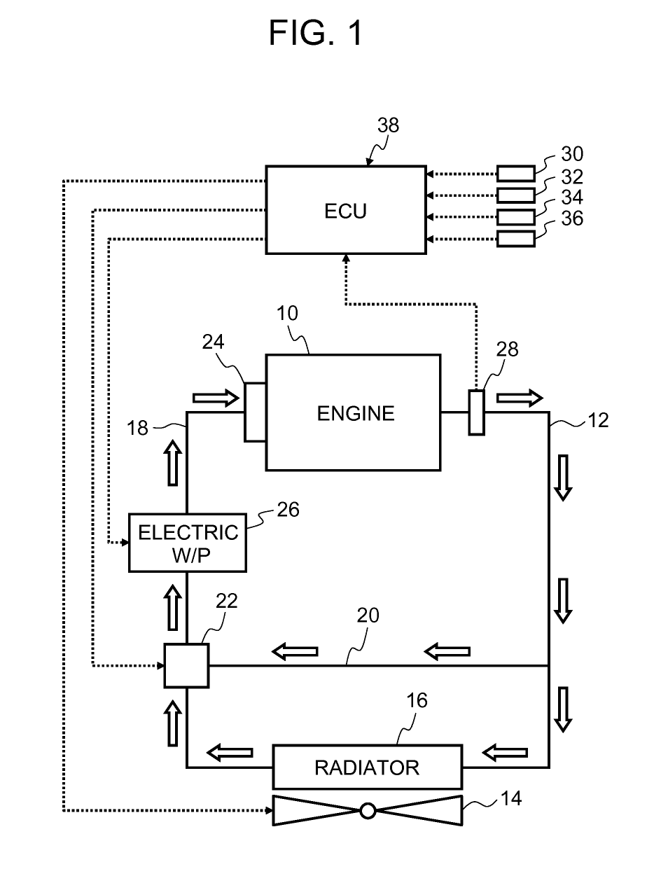

A description is made below in detail of an embodiment for carrying out the present invention with reference to the accompanying drawings. FIG. 1 illustrates a cooling system that cools an engine.

Coolant as a cooling medium, which has cooled a cylinder block, cylinder head and the like of an engine 10, passes via a first coolant passage 12, and is guided to a radiator 16 with which an electric radiator fan 14 is provided in combination. The coolant guided to radiator 16 exchanges heat with outside air at a time of passing through a radiator core attached with fins, and a temperature thereof is lowered. Then, the coolant, in which the temperature is lowered by a fact that the coolant concerned passes through radiator 16, is returned to engine 10 via a second coolant passage 18.

Moreover, first coolant passage 12 and second coolant passage 18 are allowed to communicate with each other and are connected to each other via a bypass passage 20 so that the coolant discharged from engine 10 can bypass radiator 16. On a joint portion between a downstream end of a bypass passage 20 and second coolant passage 18, an electronic control thermostat 22 is arranged, which opens and closes a passage area of bypass passage 20 in a multistage manner or continuously in a range from a full-open state to a full-close state. For example, electronic control thermostat 22 can be composed as an on-off valve that opens and closes a valve by using a phenomenon that wax built therein thermally expands by a heater, which is also built therein and is driven via a drive circuit in response to a duty ratio of a PWM signal. Hence, electronic control thermostat 22 is controlled by the duty ratio, whereby a ratio of the coolant passing through radiator 16 can be changed.

On a downstream end of second coolant passage 18 and in an intermediate portion thereof that is a downstream of electronic control thermostat 22, a mechanical water pump 24 and an electric water pump 26, which forcibly circulate the coolant between engine 10 and radiator 16, are arranged, respectively. Mechanical water pump 24 is attached so as to fill a coolant inlet of engine 10, and for example, is driven by a camshaft of engine 10. Electric water pump 26 is driven by a brushless motor, which is a drive source different from engine 10 and will be described later, in order that cooling performance can be exerted or a heating function can be maintained even in a case in which engine 10 is stopped by an idle reduction function.

As a control system that controls drive of radiator fan 14, electronic control thermostat 22 and electric water pump 26, there are attached: a coolant temperature sensor 28 as coolant temperature measuring means for measuring a temperature (coolant temperature) of the coolant discharged from engine 10; a vehicle speed sensor 30 that measures a vehicle speed; a temperature sensor 32 that measures an outside air temperature; a rotational speed sensor 34 that measures an engine rotational speed; and a load sensor 36 that measures an engine load. Then, output signals of coolant temperature sensor 28, vehicle speed sensor 30, temperature sensor 32, rotational speed sensor 34 and load sensor 36 are input to an engine control unit (hereinafter, referred to as an “ECU”) 38 that builds a computer therein, and radiator fan 14, electronic control thermostat 22 and electric water pump 26 are controlled according to a control program stored in read-only memory (ROM) thereof.

At least during an operation of engine 10, ECU 38 repeatedly determines whether or not a drive condition for driving electric water pump 26 is established. In a case of having determined that this drive condition is established, ECU 38 outputs a drive command signal to electric water pump 26, and in contrast, in a case of having determined that the drive condition is not established, ECU 38 outputs a stop command signal that stops or inhibits the drive of electric water pump 26.

The drive condition of electric water pump 26 includes a fact that an oil temperature of engine 10 is a predetermined temperature or more. With regard to a drive circuit, signal circuit or the like of electric water pump 26, for example, other drive conditions include a fact that a voltage thereof is ensured, that the circuit concerned is determined to be normal by overcurrent diagnosis, microcomputer diagnosis and relay diagnosis, that a relay is turned on, or the like.

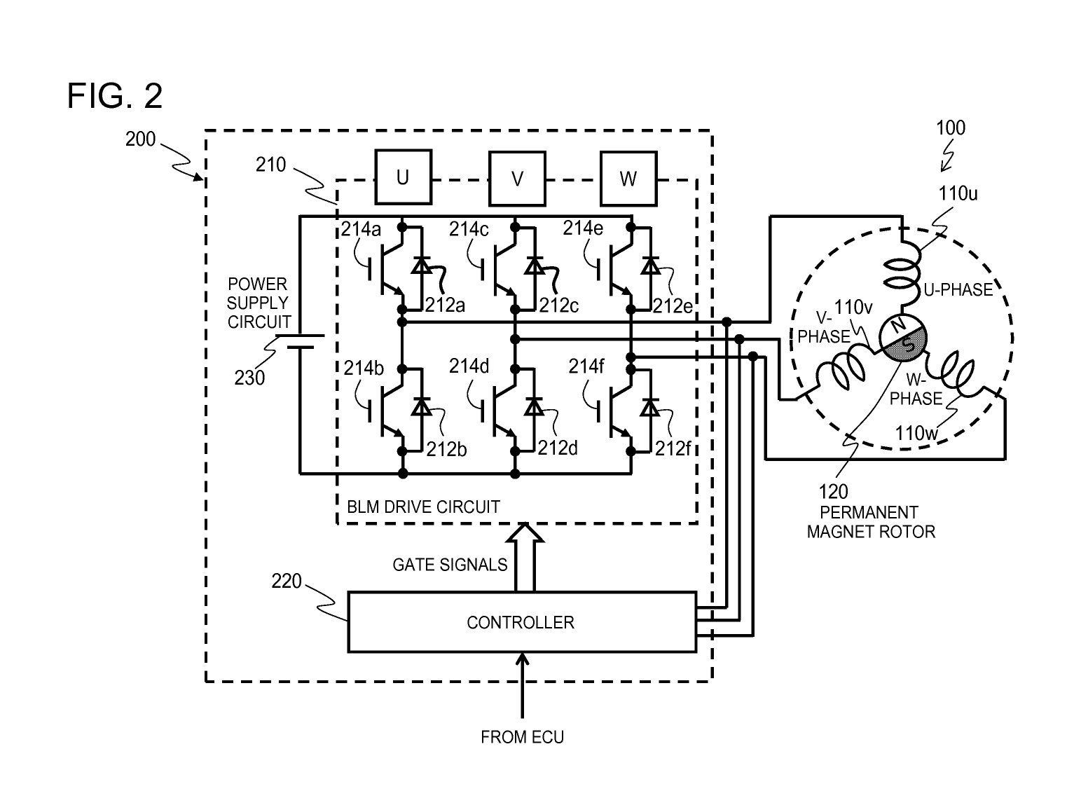

FIG. 2 illustrates an example of the brushless motor, which drives electric water pump 26, and a control device therefor.

A brushless motor 100 is a three-phase DC (direct current) brushless motor (three-phase synchronous motor), includes three-phase windings 110u, 110v and 110w of a U-phase, a V-phase and a W-phase in a cylindrical stator (not shown), and rotatably includes a rotor (permanent magnet rotor) 120 in a space formed on a center of the stator. Note that, in this specification, it is assumed that U-phase winding 110u, V-phase winding 110v and W-phase winding 110w are arranged in a clockwise rotation direction of rotor 120 in this order and with a coil phase difference of an electrical angle of 120 degrees. Moreover, it is assumed that, while a centerline of U-phase winding 110u is taken as a reference axis, a centerline of V-phase winding 110v is located at an electrical angle of 120 degrees with respect to the reference axis, and a centerline of W-phase winding 110w is located at an electrical angle of 240 degrees with respect to the reference axis.

A control device (hereinafter, referred to as a “motor control device”) 200 of brushless motor 100, which serves as a control unit, includes a drive circuit 210, and a controller 220 including a microcomputer. Motor control device 200 is not limited to one arranged in a vicinity of brushless motor 100, and for example, at least controller 220 in motor control device 200 may be formed integrally with ECU 38 or other control units.

Drive circuit 210 includes: a circuit, in which switching elements 214a to 214f composed by including anti-parallel diodes 212a to 212f are subjected to three-phase bridge connection; and a power supply circuit 230, and for example, switching elements 214a to 214f are composed of semiconductor elements such as insulated-gate bipolar transistors (IGBTs), which are used for a purpose of an electric power control. Control terminals (gate terminals) of switching elements 214a to 214f are connected to controller 220, and on/off of switching elements 214a to 214f are controlled by a PWM operation by controller 220 as will be described later.

Controller 220 is composed so as to receive the drive command signal output from ECU 38. Moreover, controller 220 includes a circuit, which receives a drive command signal for brushless motor 100 from ECU 38, computes an applied voltage as an operation amount of brushless motor 100, and generates a PWM signal based on the applied voltage. Furthermore, controller 220 includes a circuit, which sequentially switches selection patterns (hereinafter, referred to as “energization modes”) of two phases subjected to application of pulse-like voltages (hereinafter, referred to as “pulse voltages”) among such three phases according to predetermined switching timing. Then, based on the PWM signal and the energization mode, controller 220 determines by which operations respective switching elements 214a to 214f of drive circuit 210 are to be switched, and output six gate signals to drive circuit 210 according to such a determination.

Controller 220 detects the predetermined switching timing as follows. That is to say, by comparing a measured value of an induced voltage (hereinafter, referred to as a “pulse-induced voltage”), which is induced in a non-energized phase (open phase) among three phases of brushless motor 100 by applying pulse-like voltages (hereinafter, referred to as “pulse voltages”) to two phases, with a predetermined threshold value different for each of the energization modes, controller 220 detects switching timing of the energization modes. The pulse-induced voltage is one, which is generated as a voltage corresponding to a position of rotor 120 due to a fact that a saturated state of a magnetic circuit is changed depending of a position of rotor 120.

Note that the pulse-induced voltage is measured as a terminal voltage of the non-energized phase. Strictly speaking, this terminal voltage is a voltage between a ground (GND) and the terminal; however, in the present embodiment, a voltage of a neutral point is measured separately, and a difference between a voltage of this neutral point and such an inter-GND-terminal voltage is obtained, whereby terminal voltages Vu, Vv and Vw are obtained.

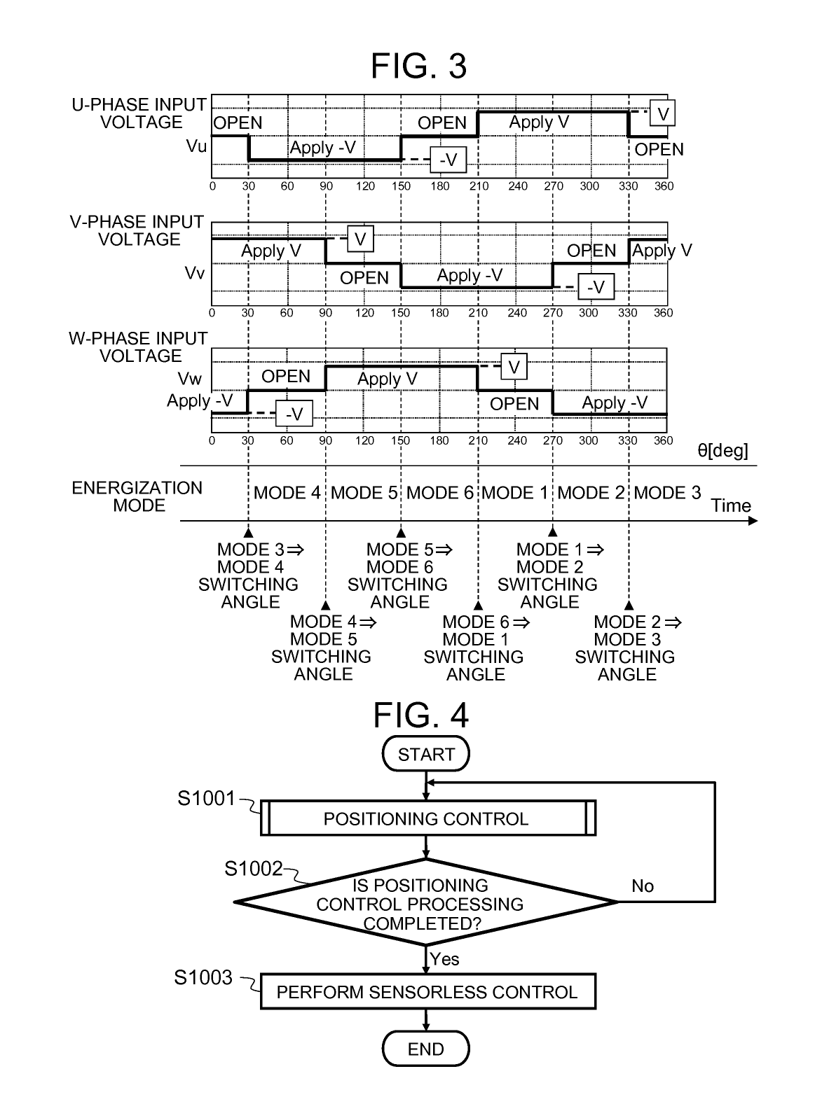

FIG. 3 illustrates voltage application states to the respective phases in the respective energization modes. The energization modes are composed of six ways of energization modes (1) to (6), which are sequentially switched for each electric angle of 60 degrees, and in each of the energization modes (1) to (6), the pulse voltage is applied to two phases (predetermined phases) selected from three phases.

In the present embodiment, an angular position of a U-phase coil is taken as a reference position (angle: 0 degree) of rotor (magnetic pole) 120. An angular position (magnetic pole position) of rotor 120 that switches over from the energization mode (3) to the energization mode (4) is set to 30 degrees. An angular position of rotor 120 that switches over from the energization mode (4) to the energization mode (5) is set to 90 degrees. An angular position of rotor 120 that switches over from the energization mode (5) to the energization mode (6) is set to 150 degrees. An angular position of rotor 120 that switches over from the energization mode (6) to the energization mode (1) is set to 210 degrees. An angular position of rotor 120 that switches over from the energization mode (1) to the energization mode (2) is set to 270 degrees. An angular position of rotor 120 that switches over from the energization mode (2) to the energization mode (3) is set to 330 degrees.

In the energization mode (1), switching element 214a and switching element 214d are controlled to be on, and all other switching elements are turned off, whereby a voltage V is applied to the U-phase, and a voltage −V is applied to the V-phase, so that an electric current is caused to flow from the U-phase to the V-phase.

In the energization mode (2), switching element 214a and switching element 214f are controlled to be on, and all other switching elements are turned off, whereby the voltage V is applied to the U-phase, and the voltage −V is applied to the W-phase, so that the electric current is caused to flow from the U-phase to the W-phase.

In the energization mode (3), switching element 214c and switching element 214f are controlled to be on, and all other switching elements are turned off, whereby the voltage V is applied to the V-phase, and the voltage −V is applied to the W-phase, so that the electric current is caused to flow from the V-phase to the W-phase.

In the energization mode (4), switching element 214b and switching element 214c are controlled to be on, and all other switching elements are turned off, whereby the voltage V is applied to the V-phase, and the voltage −V is applied to the U-phase, so that the electric current is caused to flow from the V-phase to the U-phase.

In the energization mode (5), switching element 214b and switching element 214e are controlled to be on, and all other switching elements are turned off, whereby the voltage V is applied to the W-phase, and the voltage −V is applied to the U-phase, so that the electric current is caused to flow from the W-phase to the U-phase.

In the energization mode (6), switching element 214e and switching element 214d are controlled to be on, and all other switching elements are turned off, whereby the voltage V is applied to the W-phase, and the voltage −V is applied to the V-phase, so that the electric current is caused to flow from the W-phase to the V-phase.

As described above, six energization modes (1) to (6) are sequentially switched for each electric angle of 60 degrees by the on and off of switching elements 214a to 214f, whereby each phase of brushless motor 100 is energized for an angle of 120 degrees every 180 degrees. Accordingly, an energization method as illustrated in FIG. 3 is referred to as a 120-degree energization method.

Such a switching control of the energization modes, which is as described above, is performed based on the induced voltage of the non-energized phase, and accordingly, is an energization control by a so-called position sensorless control, and particularly, is a “low-speed sensorless control” characterized in being performed based on the pulse-induced voltage induced in the non-energized phase. The low-speed sensorless control is an energization control for use in a low-speed range in a case of bisecting a motor rotational speed into the low-speed range and a high-speed range.

A high-speed sensorless control for use in the high-speed range is a control of measuring an induced voltage (hereinafter, referred to as a “speed-induced voltage”) generated by rotation of rotor 120, and switching the energization modes based on this speed-induced voltage, in which a switching point of the energization modes is set while taking as a reference a zero-cross point of such speed-induced voltages. However, with regard to the speed-induced voltage for use in the high-speed sensorless control, sensitivity to the speed-induced voltage is lowered by noise and the like when the motor rotational speed is lowered. Therefore, the high-speed sensorless control is implemented in a rotational speed range of a predetermined motor rotational speed or more, in which the switching point of the energization modes can be detected accurately based on the speed-induced voltage, that is, is implemented in the high-speed range. In contrast, in the low-speed sensorless control, the pulse-induced voltage corresponding to the position of rotor 120 can be measured without depending on the rotational speed of rotor 120, and accordingly, the low-speed sensorless control is implemented in a rotational speed range of less than the above-described predetermined motor rotational speed, in which it is difficult to perform the energization control by the high-speed sensorless control, that is, is implemented in the low-speed range.

FIG. 4 illustrates a control processing content for brushless motor 100, in which execution is started by controller 220 on occasion of output of the drive command signal from ECU 38, and the execution is ended following output of the stop command signal from ECU 38.

In Step 1001 (abbreviated as “S1001” in the drawing; this applies to the following), in order to rotate rotor 120 by the sensorless control to be described later, a positioning control of positioning rotor 120 to a predetermined position is performed. Note that details of such positioning control processing for rotor 120 will be described later.

In Step 1002, a positioning completion determination of determining whether or not the positioning control processing of Step 1001 has been completed is performed. A criterion of the positioning completion determination is, for example, that a swing of rotor 120 about the predetermined position is attenuated or assumed to be attenuated to an extent of being capable of shifting the positioning control processing to a sensorless control of Step 1003 in a case in which a time while an absolute value of a voltage generated in the non-energized phase becomes a predetermined value or less continues for a predetermined time, a case in which a predetermined time has elapsed since a positioning energization mode to be described later was switched to a different energization mode, and so on. In a case in which it is determined that the positioning control processing has been completed, the processing proceeds to Step 1003 (Yes), and in contrast, in a case in which it is determined that the positioning control processing is not completed, the processing returns to Step 1001 (No).

In Step 1003, the sensorless control for brushless motor 100 is performed. Specifically, the above-mentioned low-speed sensorless control is first performed, and in a case in which the rotational speed of brushless motor 100 is increased to reach a predetermined speed, the above-mentioned high-speed sensorless control is performed.

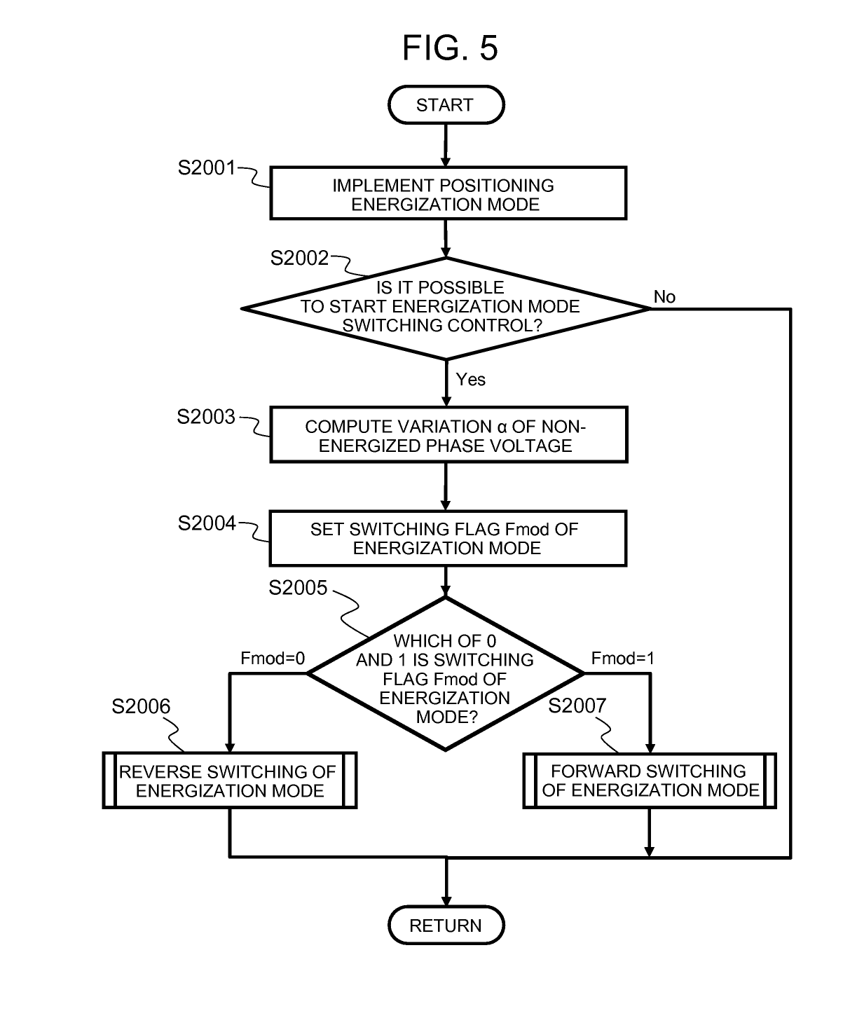

FIG. 5 illustrates the details of the positioning control processing for rotor 120 in Step 1001.

In Step 2001, the positioning energization mode is implemented so as to position rotor 120 at the predetermined position. That is to say, the voltages are applied to predetermined two phases among three phases by any of the energization modes (1) to (6) of FIG. 3, and the energization thereof is maintained, and one of magnetic poles (for example, that is an N-pole) in rotor 120 is attracted by magnetic fluxes generated in the two phases, and rotor 120 rotates so that a phase of the magnetic pole can coincide with a positioning angle set in response to the energization mode.

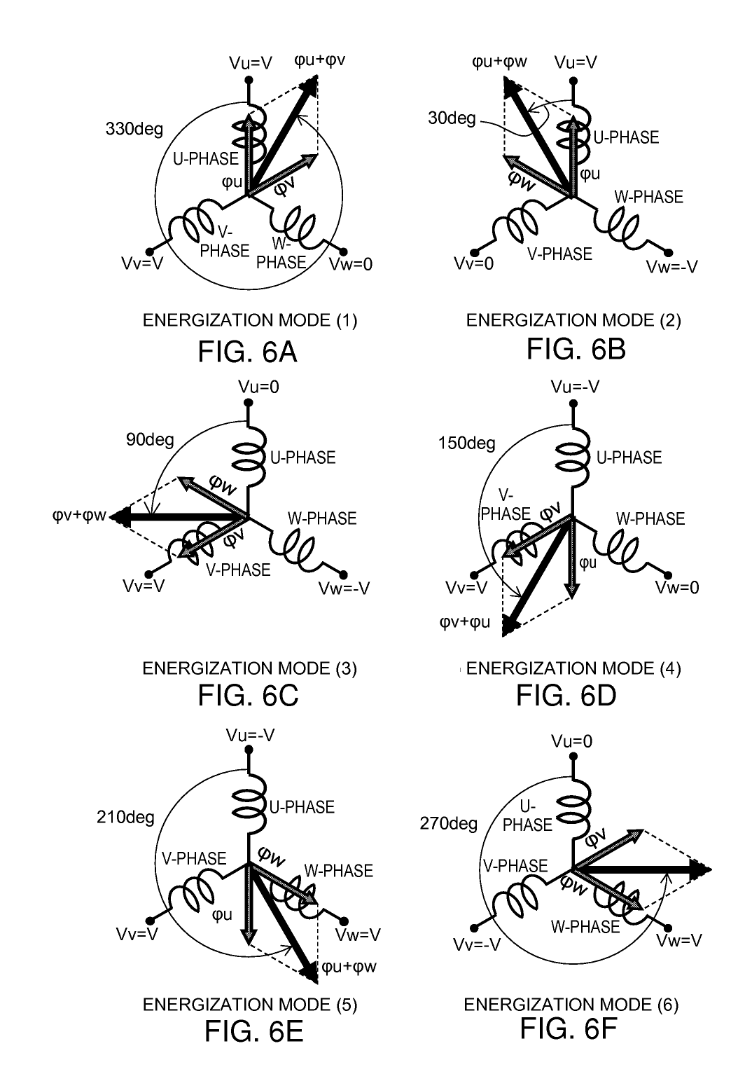

Such positioning angles set in response to the respective energization modes are phases of synthetic magnetic fluxes obtained by synthesizing magnetic fluxes generated by excitation currents of the respective phases. As illustrated in FIG. 6A to FIG. 6F, the positioning angles by the respective energization mode are: 330 degrees at a time of the energization mode (1); 30 degrees at a time of the energization mode (2); 90 degrees at a time of the energization mode (3); 150 degrees at a time of the energization mode (4); 210 degrees at a time of the energization mode (5); and 270 degrees at a time of the energization mode (6). Note that, in this description, a direction where the positioning angle is changed in a case of switching the energization modes in an ascending order is defined as a forward direction, and a direction where the positioning angle is changed in a case of switching the energization modes in a descending order is defined as a reverse direction, and a fact that the energization modes are switched in the ascending order is referred to as that the energization modes are switched in the “forward direction”, and a fact that the energization modes are switched in the descending order is referred to as that the energization modes are switched in the “reverse direction”.

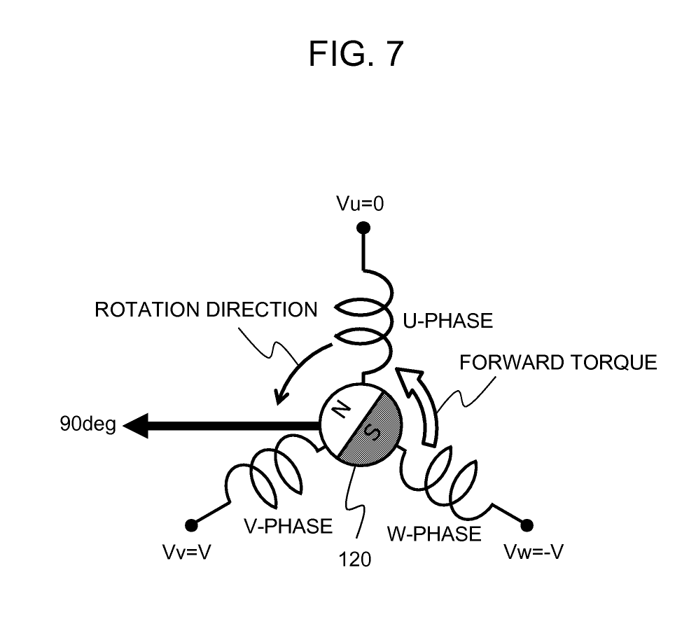

In the present embodiment, as illustrated in FIG. 7, for example, the energization mode (3) is set as the positioning energization mode, the voltage V is applied to the V-phase, and the voltage −V is applied to the W-phase, whereby the current is caused to flow from the V-phase to the W-phase, and the positioning angle is set to 90 degrees. In this case, the U-phase becomes the non-energized phase. In a case in which rotor 120 remains still in such a phase as illustrated in FIG. 7, rotor 120 receives forward torque, and a magnetic pole N of rotor 120 starts to rotate in a forward direction toward 90 degrees of the positioning angle.

As the applied voltage V in each of the energization modes, a voltage, at which rotor 120 can operate against friction at a temperature where viscosity or the like of the coolant in the cooling system becomes highest, is set in order to enable the rotation of rotor 120 in the positioning control processing under all temperature conditions where electric water pump 26 is used. The applied voltage V may be set in response to the temperature, for example, so as to be set lower as a temperature such as the coolant temperature measured by coolant temperature sensor 28 and the outside air temperature measured by temperature sensor 32 is becoming higher.

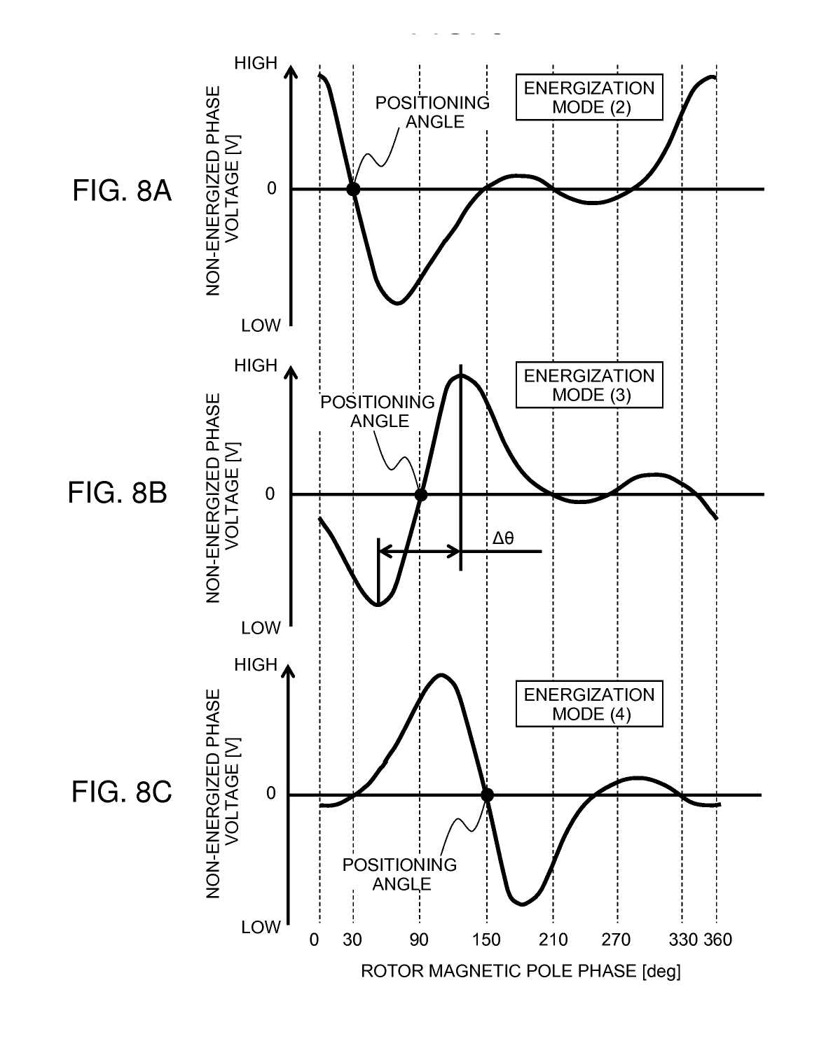

Note that such pulse-induced voltages, which are generated in the non-energized phases in a case of allowing rotor 120 to make one gentle rotation, individually form such voltage waveforms as in FIG. 8A to FIG. 8C particularly with regard to the energization mode (2), the energization mode (3) and the energization mode (4).

In each of the voltage waveforms of FIG. 8A to FIG. 8C, in a case in which the magnetic pole phase of rotor 120 coincides with the positioning angle, the pulse-induced voltage generated in the non-energized phase becomes substantially zero (refer to black circle marks in the drawings). Then, the voltage waveform as described above is stored in advance, whereby the position of rotor 120 can also be specified based on the stored voltage waveform and the pulse-induced voltage generated in the non-energized phase. However, in an actual positioning control, the speed-induced voltage, which corresponds to the rotational speed of rotor 120 that causes a swing in which the phase of the magnetic pole is increased and decreased with respect to the positioning angle, is superimposed on the pulse-induced voltage generated in the non-energized phase. Therefore, the voltage waveform of the non-energized phase becomes a different one (not becoming zero) particularly in a vicinity of the positioning angle with respect to each of the voltage waveforms illustrated in FIG. 8A to FIG. 8C. Hence, in consideration of an influence of such a speed-induced voltage, controller 220 does not specify the magnetic pole position of rotor 120 with reference to the voltage waveforms of FIG. 8A to FIG. 8C. However, in this description, it is assumed that the voltage waveforms of FIG. 8A to FIG. 8C are used as the voltages generated in the non-energized phases for convenience of the explanation.

In Step 2002, it is determined whether or not it is possible to start an energization mode switching control of switching the positioning energization modes.

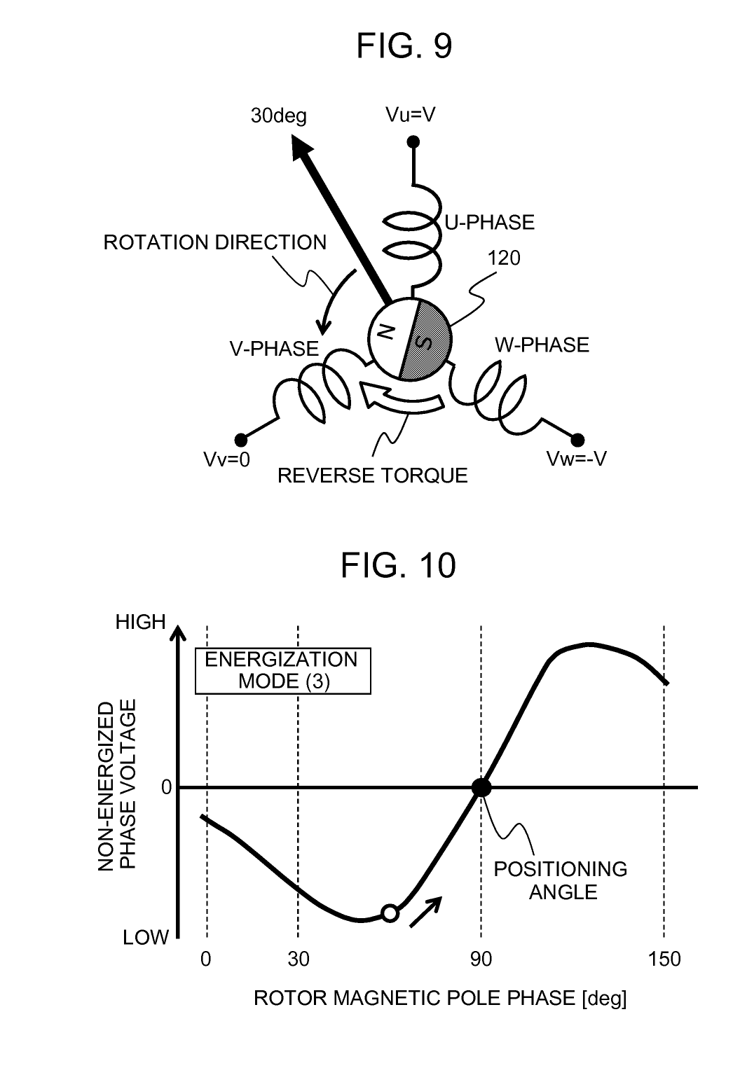

A reason for switching the positioning energization modes is as follows. Specifically, while rotor 120 that has started the rotation as illustrated in FIG. 7 causes the swing, in which the phase of the magnetic pole (for example, the N-pole) is increased and decreased with respect to the positioning angle, by the implementation of the positioning energization mode of Step 2001, this swing becomes less likely to be attenuated as inertia (moment of inertia) of a body of rotation of electric water pump 26 or of rotor 120 itself is becoming larger. Hence, it takes long to position rotor 120, and accordingly, it is apprehended that the start of the sensorless control in Step 1003 mentioned above may be delayed, and that starting responsiveness of electric water pump 26 and the like may be lowered. For this, as illustrated in FIG. 9, the positioning energization mode is switched appropriately, whereby, for rotor 120 that rotates, torque is generated in a direction reverse to the rotation direction, and the swing is reduced, that is, a “brake” is applied. In this way, such a time required to position rotor 120 can be shortened, and this is the reason.

In a case of implementing, by controller 220, this step for the first time after the control for brushless motor 100 is started on occasion of the output of the drive command signal from ECU 38, a criterion of enabling the start of the energization mode switching control is that it is estimated that, in FIG. 8B, the magnetic pole phase of rotor 120 remains within a range where the voltage of the non-energized phase is increased and decreased by the swing of rotor 120 in response to that the magnetic pole phase of rotor 120 is increased and decreased while sandwiching the positioning angle, for example, from such a fact that a predetermined time has elapsed from the implementation of the positioning energization mode in Step 2001. For example, in a case of setting the positioning energization mode to the energization mode (3), the criterion is that it is estimated that the magnetic pole phase of rotor 120 remains within a range of Δθ of FIG. 8B.

In contrast, in implementing this step for the second time and after, a fact that a current state is not a state in which it becomes rather difficult to attenuate the swing of rotor 120 by switching the positioning energization mode to a different energization mode to apply the “brake” serves as the criterion for starting the energization mode switching control. For example, such a negative state includes a phenomenon that the absolute value of the voltage generated in the non-energized phase exceeds the predetermined voltage.

In Step 2002, in a case in which it is determined that it is possible to start the energization mode switching control, then the positioning control processing proceeds to Step 2003 (Yes), and in a case in which it is determined that it is not possible to start the energization mode switching control, then the positioning control processing is ended (No).

In Step 2003, a time variation α of the induced voltage generated in the non-energized phase (for example, the U-phase) is computed. Specifically, controller 220 includes measuring means for measuring the voltage of the non-energized phase every micro time Δt, and a subtraction value (V1−V2) is obtained from a voltage V1 measured this time and a voltage V2 measured the previous time is obtained among such voltages of the non-energized phase, which are measured by the measuring means, and this subtraction value is divided by the micro time Δt, whereby the time variation α is computed. Note that the subtraction value (V1−V2) may be used as the time variation α.

Reasons why the time variation α is computed are as follows. Specifically, as mentioned above, the speed-induced voltage corresponding to the rotational speed of rotor 120 is superimposed on the voltage of the non-energized phase, and it is difficult to specify the magnetic pole phase of rotor 120 from the voltage waveforms of FIG. 8A to FIG. 8C, and moreover, in which of the forward direction and the reverse direction rotor 120 rotates just needs to be estimated.

In Step 2004, a switching flag Fmod of the energization mode is set. For the positioning energization mode, the switching flag Fmod of the energization mode is a flag indicating either of forward switching of switching the energization mode by one step in the forward direction and reverse switching of switching the energization mode by one step in the reverse direction. Here, a case of Fmod=0 indicates the reverse switching, and a case of Fmod=1 indicates the forward switching. In a case in which the positioning energization mode is the energization mode (3) as in the present embodiment, Fmod=0 indicates that the energization mode (3) is to be switched to the energization mode (2), and Fmod=1 indicates that the energization mode (3) is to be switched to the energization mode (4).

To which value the switching flag Fmod of the energization mode is to be set, that is, which of the forward switching and the reverse switching is to be set depends on whether or not the variation α computed in Step 2003 is less than zero (0). In a case in which the time variation α is 0 or more, Fmod=0 is set so as to perform the reverse switching, and in contrast, in a case in which the time variation α is less than 0, Fmod=1 is set so as to perform the forward switching.

For example, if rotor 120 rotates in the forward direction in the case in which the positioning energization mode is the energization mode (3) as in FIG. 7, then as shown in FIG. 10, the voltage generated in the non-energized phase is increased from a void circle mark in the drawing, and the time variation α becomes 0 or more, and accordingly, Fmod=0 is set so as to perform the reverse switching of the positioning energization mode.

Note that, in order to alternately implement the switching of the energization mode between the forward direction and the reverse direction, such a condition may be adopted, in which the previous setting is Fmod=0 at a time of setting Fmod=1 in this step and the previous setting is Fmod=1 in a case of setting Fmod=0 in this step, excluding a case of implementing this step for the first time after the control for brushless motor 100 is started on occasion of the output of the drive command signal from ECU 38.

In Step 2005, it is determined whether the switching flag Fmod of the energization mode is 0 or 1. In a case of Fmod=0, the processing proceeds to Step 2006 so as to perform the reverse switching, and in contrast, in a case of Fmod=1, the processing proceeds to Step 2007 so as to perform the forward switching.

In Step 2006, the reverse switching of the energization mode is performed. Details of the reverse switching of the energization mode will be described later.

In Step 2007, the forward switching of the energization mode is performed. Details of the forward switching of the energization mode will be described later.

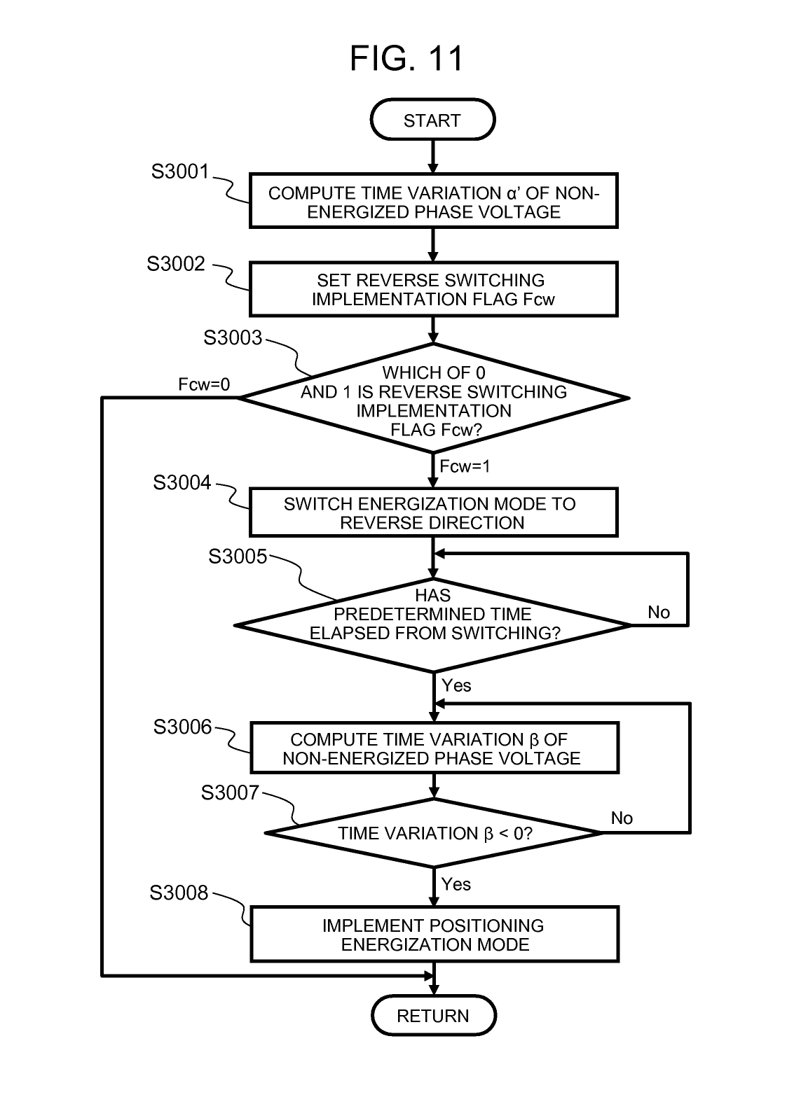

FIG. 11 illustrates the details about the reverse switching processing for the energization mode in Step 2006.

In Step 3001, a time variation α′ of the voltage, which is generated in the non-energized phase (for example, the U-phase), in the micro time Δt is computed in a similar way to Step 2003.

In Step 3002, a reverse switching implementation flag Fcw of the energization mode is set. The reverse switching implementation flag Fcw of the energization mode is a flag indicating whether or not to implement the reverse switching of the energization mode. Here, a case of Fcw=1 indicates that the reverse switching is to be implemented, and a case of Fcw=0 indicates that the reverse switching is not to be implemented.

A reason why the reverse switching implementation flag Fcw indicating whether or not to implement the reverse switching is further set after the switching flag Fmod=0 indicating that the energization mode is to be switched to the reverse direction is set is in order to confirm again that the rotation direction of rotor 120 is the forward direction, and to prevent the “brake” for rotor 120 from accelerating rotor 120 on the contrary. In the case in which the positioning energization mode is the energization mode (3) as in the present embodiment, Fcw=0 indicates that the switching to the energization mode (2) is not to be implemented, and Fcw=1 indicates that the switching to the energization mode (2) is to be implemented.

In a case in which the time variation α′ is less than 0, Fcw=0 is set so as to discontinue the implementation of the reverse switching, and in contrast, in a case in which the time variation α′ is 0 or more, Fcw=1 is set so as to implement the reverse switching.

In Step 3003, it is determined whether the reverse switching implementation flag Fcw is 0 or 1. In a case of Fcw=0, the reverse switching of the energization mode is not implemented, and accordingly, the reverse switching processing for the energization mode is ended so as to determine whether or not the positioning control processing in Step 1002 has been completed. In contrast, in a case of Fcw=1, the processing proceeds to Step 3004 so as to implement the reverse switching of the energization mode.

In Step 3004, the energization mode is switched from the positioning energization mode to the reverse direction. In the case in which the positioning energization mode is the energization mode (3) as in the present embodiment, the energization mode is switched to the energization mode (2).

In Step 3005, it is determined whether or not a predetermined time has elapsed since the energization mode was switched to the reverse direction in Step 3004. The predetermined time is a time while a reflux current flowing in the non-energized phase following the switching of the energization mode is generated.

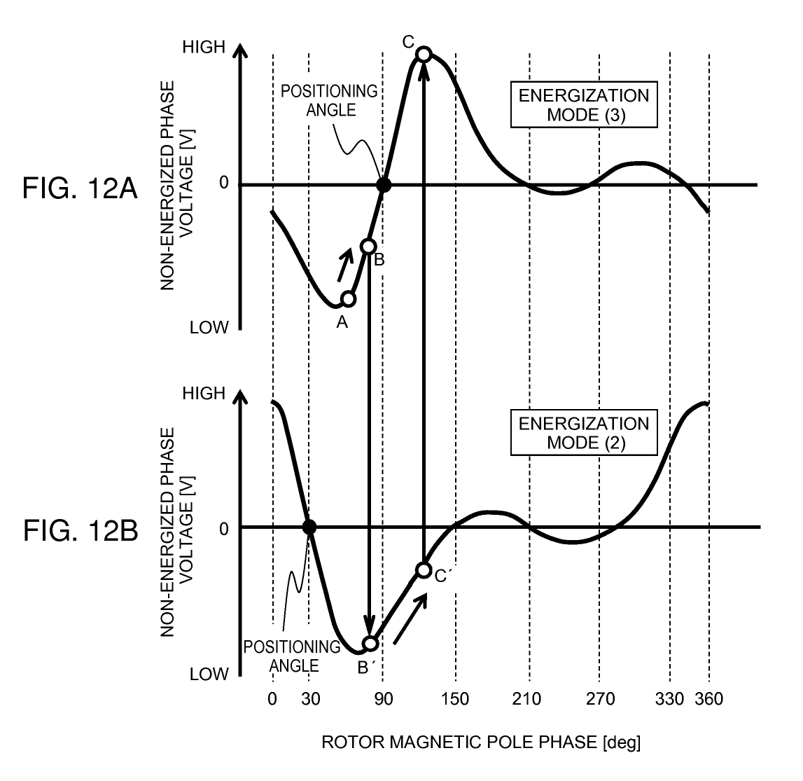

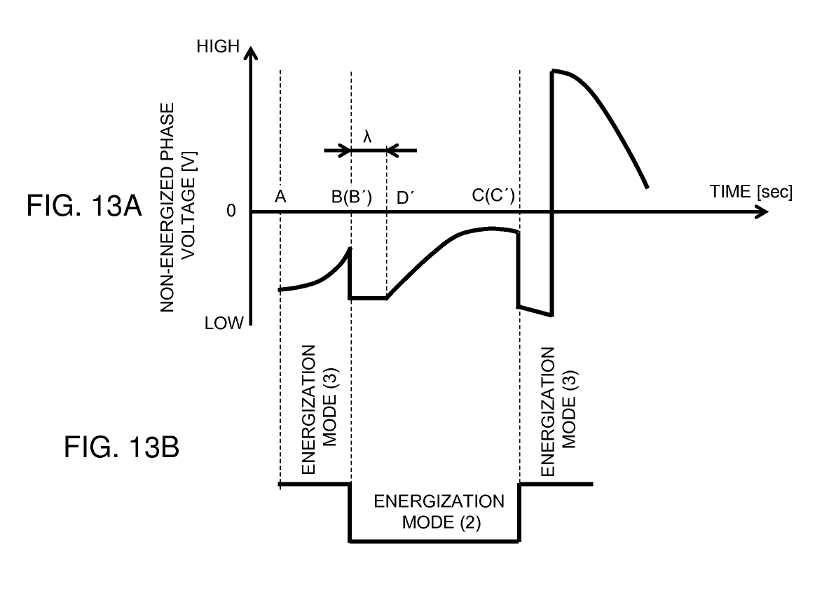

Here, a description is made of a reason why it is determined whether or not the predetermined time has elapsed. As in FIG. 12A and FIG. 12B, in the energization mode (3) that is the positioning energization mode, in a case in which the energization mode is switched to the energization mode (2) at a place where the voltage generated in the non-energized phase (U-phase) is changed from a point A to a point B as a result that rotor 120 rotates in the forward direction, and the energization mode (2) returns to the positioning energization mode as will be described later in Step 3008 at a place where the voltage generated in the non-energized phase (V-phase) is changed from a point B′ to a point C′ as a result that rotor 120 rotates in the forward direction, then a time change of the voltage generated in the non-energized phase becomes as in FIG. 13A.

As illustrated in FIG. 13A, during a time λ while the energization mode is switched from the energization mode (3) that is the positioning energization mode to the energization mode (2) and the reflux current flows in the non-energized phase (V-phase), the voltage of the non-energized phase (V-phase) is fixed to the GND (ground) voltage. Therefore, during this time λ, even if the time variation is computed for the voltage of the non-energized phase as in Step 3006 that will be described later, it cannot be estimated whether rotor 120 rotates in the forward direction or the reverse direction. Accordingly, in order not to compute the time variation for the voltage of the non-energized phase until the time λ elapses, the time λ is defined as the predetermined time, and it is determined whether or not the predetermined time has elapsed from the switching of the energization mode in Step 3004.

In Step 3005, in a case in which it is determined that the predetermined time has elapsed, the processing proceeds to Step 3006 (Yes), and in contrast, in a case in which it is determined that the predetermined time has not elapsed, this step is repeated (No). Note that, in a case of giving priority to reduction of a load of the processing by controller 220, Step 3005 does not have to be implemented. This also applies to the forward switching processing, which will be described later, in a similar way.

In Step 3006, a time variation β of the voltage generated in the non-energized phase (V-phase) is computed in a similar way to Step 2003.

In Step 3007, it is determined whether or not the time variation β of the voltage generated in the non-energized phase (V-phase) is less than 0 so that the timing of returning the energization mode to the positioning energization mode can be detected.

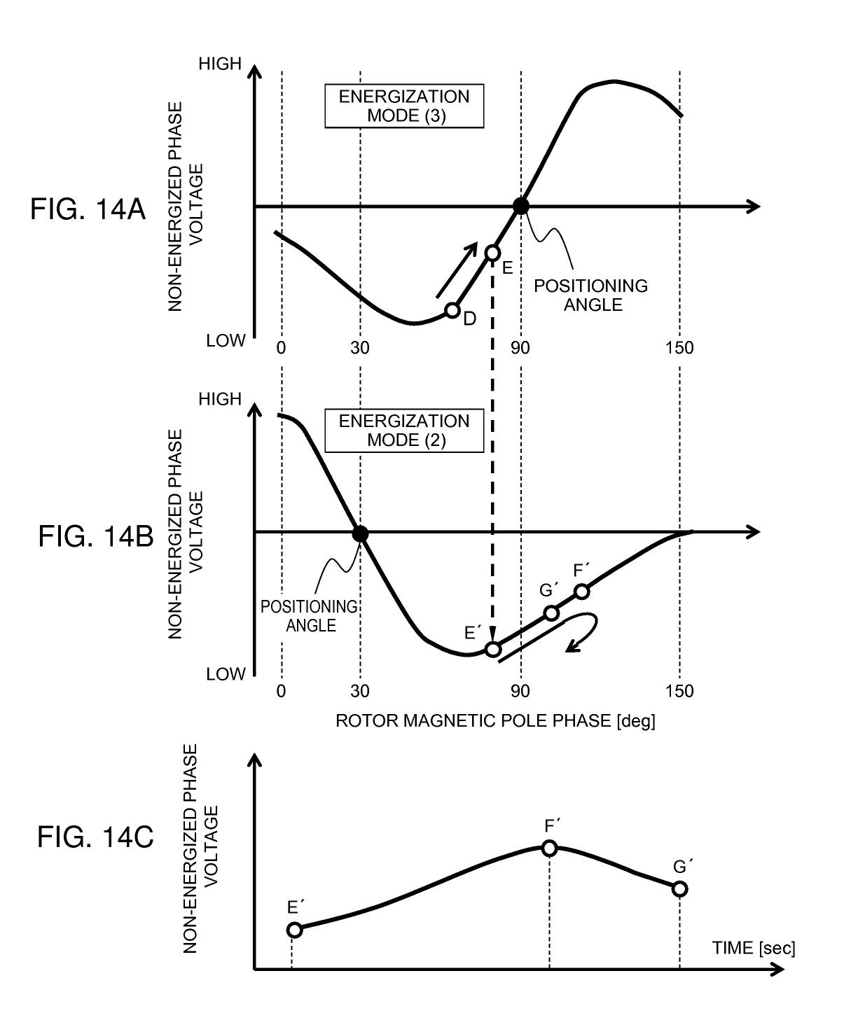

Here, a description is made of a reason of detecting the timing of returning the energization mode to the positioning energization mode based on the time variation β of the voltage generated in the non-energized phase. As illustrated in FIG. 14, in the energization mode (3) that is the positioning energization mode, in a case in which rotor 120 rotates in the forward direction, and the voltage generated in the non-energized phase (U-phase) is changed from a point D to a point E, when the energization mode is switched to the energization mode (2) at a point E, then the voltage generated in the non-energized phase (V-phase) is changed from a point E′ to a point F′ since rotor 120 rotates in the forward direction by the inertia even after the switching. However, the positioning angle of the energization mode (2) is 30 degrees, in which the reverse torque acts on rotor 120 and the “brake” functions thereon, and accordingly, the forward rotation of rotor 120 is stopped eventually, and rotor 120 starts to rotate in the reverse direction. Therefore, the voltage of the non-energized phase (V-phase) is increased from a point E′ to, for example, a point F′, and thereafter, is gradually decreased toward the point E′. That is to say, as illustrated in FIG. 14C, with regard to the voltage of this non-energized phase (V-phase), a polarity (positive/negative) of a time variation thereof is inverted at the point F′ taken as a boundary. Then, if the energization mode (2) is maintained in the case in which rotor 120 starts to rotate in the reverse direction, the swing of rotor 120 is rather increased, and accordingly, the energization mode (2) is returned to the energization mode (3) that is the positioning energization mode when the time variation is changed to less than 0.

In Step 3007, in a case in which it is determined that the time variation β of the voltage generated in the non-energized phase (V-phase) is less than 0, the processing proceeds to Step 3008 (Yes). In contrast, in a case in which it is determined that the time variation β of the voltage generated in the non-energized phase (V-phase) is 0 or more, the processing returns to Step 3006 (No).

In Step 3008, the positioning energization mode is implemented. In such a case of returning the energization mode (2) to the positioning energization mode, then as illustrated in FIG. 13A, a phenomenon that the voltage generated in the non-energized phase (U-phase) is fixed to the GND voltage by the reflux can occur in a similar way to the case in which the positioning energization mode is switched to the energization mode (2) in Step 3004. Moreover, in Step 1002 implemented after this step, it is determined whether or not the positioning control processing has been completed based on the voltage itself of the non-energized phase. Hence, in a case of executing Step 1002, such an operation as in Step 3005 may be performed, in which the voltage of the non-energized phase is not measured until the reflux time elapses since the positioning energization mode is implemented in this step. Moreover, the voltage of the non-energized phase may be measured after detection of an edge when the voltage of the non-energized phase rises again after being fixed to the GND voltage. This also applies to the forward switching processing, which will be described later, in a similar way. Note that Step 2001 becomes unnecessary by implementing this step.

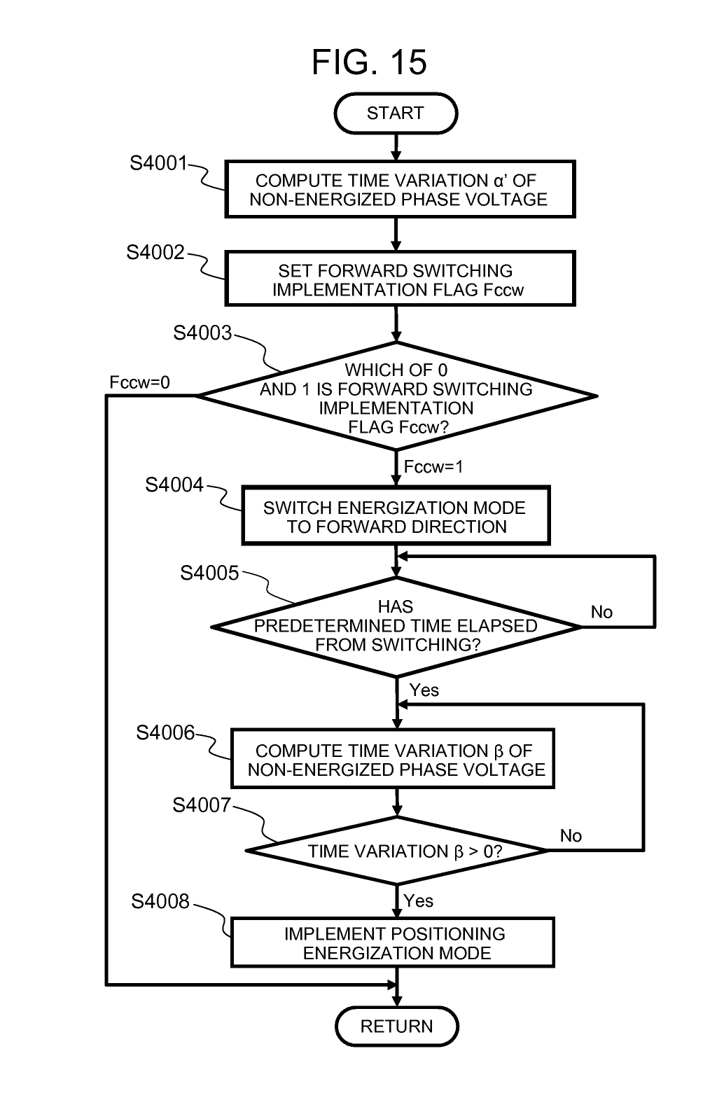

FIG. 15 illustrates details about the forward switching processing of the energization mode in Step 2007. Note that the forward switching processing is similar to the reverse switching processing of FIG. 11 except that the forward torque is generated for rotor 120 that rotates in the reverse direction, and accordingly, the description is made while being simplified or omitted.

In Step 4001, a time variation α′ of the voltage, which is generated in the non-energized phase (for example, the U-phase), in the micro time Δt is computed in a similar way to Step 2003.

In Step 4002, a forward switching implementation flag Fccw of the energization mode is set. The forward switching implementation flag Fccw is a flag indicating whether or not to implement the forward switching of the energization mode. Here, a case of Fccw=1 indicates that the forward switching is to be implemented, and a case of Fccw=0 indicates that the forward switching is not to be implemented. In the case in which the positioning energization mode is the energization mode (3) as in the present embodiment, Fccw=0 indicates that the switching to the energization mode (4) is not to be implemented, and Fccw=1 indicates that the switching to the energization mode (4) is to be implemented.

In a case in which the time variation α′ is less than 0, Fccw=0 is set so as to discontinue the implementation of the forward switching, and in contrast, in a case in which the time variation α′ is 0 or more, Fccw=1 is set so as to implement the forward switching.

In Step 4003, it is determined whether the forward switching implementation flag Fccw is 0 or 1. In a case of Fccw=0, the forward switching of the energization mode is not implemented, and accordingly, the forward switching processing for the energization mode is ended so as to determine whether or not the positioning control processing in Step 1002 has been completed. In contrast, in a case of Fccw=1, the processing proceeds to Step 4004 so as to implement the forward switching of the energization mode.

In Step 4004, the energization mode is switched from the positioning energization mode to the forward direction.

In the case in which the positioning energization mode is the energization mode (3) as in the present embodiment, the energization mode is switched to the energization mode (4).

In Step 4005, it is determined whether or not a predetermined time has elapsed since the energization mode was switched to the forward direction in Step 4004. The predetermined time is a time while the reflux current flowing in the non-energized phase following the switching of the energization mode is generated. In a case in which it is determined that the predetermined time has elapsed, the processing proceeds to Step 4006 (Yes), and in contrast, in a case in which it is determined that the predetermined time has not elapsed, this step is repeated (No).

In Step 4006, the time variation β of the voltage generated in the non-energized phase (V-phase) is computed in a similar way to Step 2003.

In Step 4007, it is determined whether or not the time variation β of the voltage generated in the non-energized phase (V-phase) is less than 0 so that the timing of returning the energization mode to the positioning energization mode can be detected. In a case in which it is determined that the time variation β of the voltage generated in the non-energized phase (V-phase) is less than 0, the processing proceeds to Step 4008 (Yes). In contrast, in a case in which it is determined that the time variation β of the voltage generated in the non-energized phase (V-phase) is 0 or more, the processing returns to Step 4006 (No).

In Step 4008, the positioning energization mode is implemented.

According to motor control device 200 as described above, for rotor 120 that rotates by the positioning energization mode, the torque is generated in the direction reverse to the rotation direction, whereby the “brake” can be applied thereto. Therefore, even if the inertia of the body of rotation of electric water pump 26, which is driven by brushless motor 100, or the inertia of rotor 120 becomes large, the swing of rotor 120 with respect to the positioning angle in the positioning energization mode does not become prone to be attenuated. Hence, the time required to position rotor 120 can be shortened, for example, from approximately 0.8 second to 0.115 second, and accordingly, it becomes possible to quickly start the sensorless control in Step 1003, and the starting responsiveness of electric water pump 26 is enhanced.

Note that, in the above-mentioned embodiment, in a predetermined case, the processing of Step 2002 to Step 2007, in which the “brake” is applied to rotating rotor 120 by switching the positioning energization mode in the forward direction or the reverse direction, does not have to be implemented. This is because, when the coolant temperature is lowered to increase friction of electric water pump 26 due to temperature dependency of the viscosity of the coolant in the cooling system, this friction serves as the “brake”, and the swing of rotor 120 becomes likely to be attenuated. Hence, for example, the above-mentioned predetermined case is a case in which an actually measured value of the coolant temperature becomes a lower limit value of the coolant temperature or less, the coolant temperature achieving coolant viscosity that does not affect the starting responsiveness of electric water pump 26 even if the “brake” is not applied by the switching of the positioning energization mode.

Separately from this, the above-mentioned predetermined case may be defined as a case in which, for example, the time variation of the voltage of the non-energized phase at the zero-cross point or the like is a predetermined ratio or less on the premise that the voltage of the non-energized phase remains within the range of AO of FIG. 8B. Even if the magnetic pole phase of the rotor is the same, the time variation of the non-energized phase voltage is lowered as the viscosity of the coolant is becoming higher, and accordingly, the above-mentioned predetermined ratio is an upper limit value of the time variation in a case in which the viscosity of the coolant does not affect the starting responsiveness of electric water pump 26.

In the above-mentioned embodiment, the positioning energization mode is switched to the reverse direction or the forward direction (Step 3004, Step 4004), and the torque is generated for rotating rotor 120 in the direction reverse to the rotation direction, whereby the “brake” is applied; however, a size of this “brake” may be gradually reduced in response to a time elapsed from the implementation of the positioning energization mode of Step 2001. Specifically, in a case in which the energization mode is switched from the energization mode (3) that is the positioning energization mode to the energization mode (2) or the energization mode (4), the motor application voltage V in the energization mode (2) or the energization mode (4) is reduced in response to the time elapsed from the implementation of the positioning energization mode. In this way, the torque generated in the direction reverse to the rotation direction of rotor 120 can be lowered, and the size of the “brake” can be gradually reduced. Accordingly, such a possibility that the swing of rotor 120 may rather become less likely to be attenuated due to excessive functioning of the “brake” is reduced.

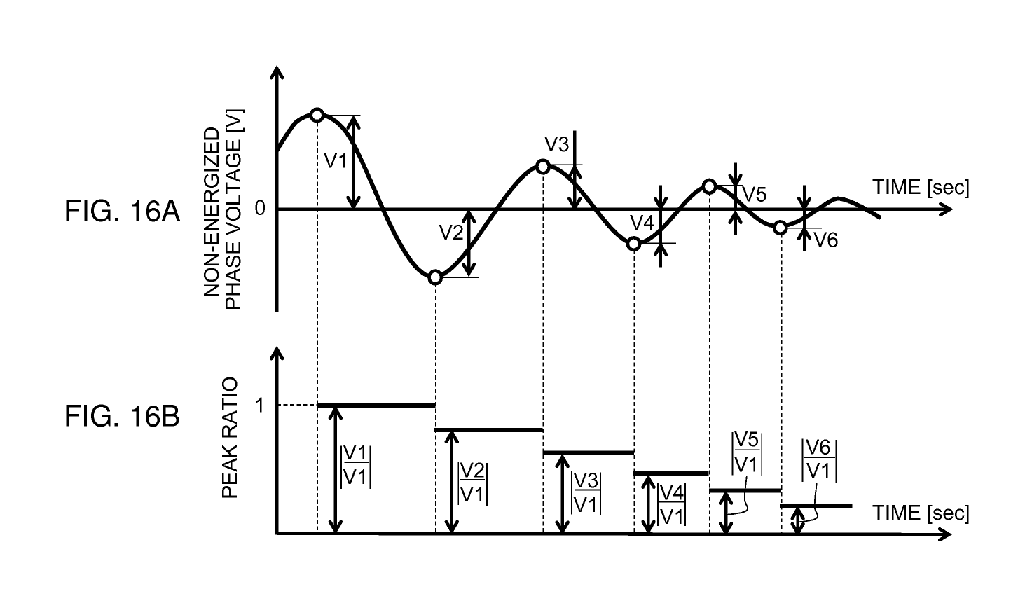

Moreover, in place of the above-mentioned method of gradually reducing the size of the “brake” in response to the time, the size of the “brake may be gradually reduced in response to amplitude of the voltage of the non-energized phase in the positioning energization mode. As illustrated in FIG. 16A, with regard to the voltage of the non-energized phase in the positioning energization mode, peak voltages (void circle marks in the drawing) thereof, which become gradually smaller as the swing of rotor 120 is being attenuated, are sequentially measured after it is determined in Step 2002 that the switching control for the energization modes can be started. Moreover, as illustrated in FIG. 16B, peak voltage ratios |V1/V1|, |V2/V1|, |V3/V1|, |V4/V1|, |V5/V1|, |V6/V1 | . . . , which are obtained by dividing the respective peak values V1, V2, V3, V4, V5, V6 . . . by the peak voltage V1 measured first, and are converted into absolute values, are sequentially computed. Then, in a case of implementing Step 3004 or Step 4004 for the first time after computing the peak voltage ratios, a voltage obtained by multiplying the motor application voltage V (or −V) by the latest peak voltage ratio is applied, and the energization mode (2) or the energization mode (4) is implemented. Also in this way, it is possible to lower the torque generated in the direction reverse to the rotation direction of rotor 120, and to gradually reduce the size of the “brake”, and accordingly, there can be avoided such a phenomenon that the shortening of the time required to position rotor 120 is inhibited due to the excessive functioning of the “brake”.

Note that it is possible to gradually reduce the size of the “brake” not only in response to the time and the voltage of the non-energized phase in the positioning energization mode but also in response to the above-mentioned coolant temperature and time variation. For example, the size of the “brake” is reduced following an increase in coolant temperature, and in contrast, the size of the “brake” is gradually increased according to an decrease in coolant temperature. Moreover, for example, the size of the “brake” is gradually reduced following the increase of the time variation, and in contrast, the size of the “brake” is gradually increased according to the decrease of the time variation.

Brushless motor 100 is not only applied to the power source of electric water pump 26 as mentioned above, but also applicable to variety of purposes such as a power source of an oil pump that provides a lubricating/cooling function and/or oil pressure to an engine, transmission and the like, and an electric actuator for actuating a variety of mechanical components of a vehicle.

Here, technical ideas other than claims, which can be grasped from the above-described embodiment, are described below together with effects thereof.

(A) A control device for a brushless motor, according to any one of claims 1 to 3, the control device energizing two phases among a plurality of phases of the brushless motor and positioning a rotor to a predetermined position in a case of having received a start command of the brushless motor, wherein, in a case in which the positioning energization mode of energizing the two phases is temporarily switched to an energization mode of energizing other two phases different from the two phases, the positioning energization mode is implemented after elapse of a predetermined time at a time of resuming the positioning energization mode. In this way, even if the reflux current flows in the non-energized phase in the case in which the energization mode is switched from the positioning energization mode, if the predetermined time is set at the time while the reflux current is flowing, then it becomes impossible to compute the time variation for the voltage of the non-energized phase. Hence, the time variation of the non-energized phase voltage can be computed accurately.

(B) The control device for a brushless motor, according to any one of claims 1 to 3 and (A), wherein the positioning energization mode is temporarily switched to the energization mode of energizing the other two phases in response to whether a variation of the voltage generated in the non-energized phase is positive or negative, or in response to whether a gradient of the voltage generated in the non-energized phase is positive or negative. In this way, in which of the forward direction and the reverse direction the rotor rotates can be estimated, even if the speed-induced voltage corresponding to the rotational speed of the rotor is superimposed on the voltage of the non-energized phase and it is difficult to specify the rotor magnetic pole phase.

(C) The control device for a brushless motor, according to any one of claims 1 to 3, and (A) and (B), wherein, in a case in which the positioning energization mode is temporarily switched to the energization mode of energizing the other two phases, the energization mode of energizing the other two phases is switched again to the positioning energization mode in response to whether the variation of the voltage generated in the non-energized phase is positive or negative, or in response to whether the gradient of the voltage generated in the non-energized phase is positive or negative. In this way, in which of the forward direction and the reverse direction the rotor rotates can be estimated, even if the speed-induced voltage corresponding to the rotational speed of the rotor is superimposed on the voltage of the non-energized phase and it is difficult to specify the rotor magnetic pole phase.

(D) The control device for a brushless motor, according to any one of claims 1 to 3 and (A) to (C), wherein a variation of the voltage generated in the non-energized phase in the case of switching the positioning energization mode to the energization mode of energizing the other two phases is inverted in polarity (positive/negative) with respect to a variation of the voltage generated in the non-energized phase in the case of switching the energization mode of energizing the other two phases to the positioning energization mode. In this way, it is easy to determine whether or not to switch the energization mode.

(E) The control device for a brushless motor, according to any one of claims 1 to 3 and (A) to (C), wherein a gradient of the voltage generated in the non-energized phase in the case of switching the positioning energization mode to the energization mode of energizing the other two phases is inverted in polarity (positive/negative) with respect to a gradient of the voltage generated in the non-energized phase in the case of switching the energization mode of energizing the other two phases to the positioning energization mode. In this way, it is easy to determine whether or not to switch the energization mode.

(F) The control device for a brushless motor, according to any one of claims 1 to 3 and (A) to (E), wherein, in a case in which the brushless motor drives an electric pump, the positioning energization mode energizes a voltage at which the rotor is rotatable to the two phases in response to a temperature of a medium fed with pressure by the electric pump. In this way, there is obtained an advantage that, in the positioning control, useless electric power is not consumed while enabling the rotation of the rotor against friction with the medium fed with pressure by the electric pump.

(G) The control device for a brushless motor, according to any one of claims 1 to 3 and (A) to (E), wherein, in a case in which the brushless motor drives the electric pump, the energization mode of energizing the other two phases changes the voltage, which is energized to the other two phases, in response to viscosity of the medium fed with pressure by the electric pump. If the a temperature of the medium is lowered and the friction of the electric water pump is increased due to temperature dependency of the viscosity of the medium fed with pressure by the electric pump, then this friction serves as the “brake”, and the swing of the rotor becomes likely to be attenuated. Therefore, useless electric power is not consumed in such a case in which the “brake” is not required.

(H) The control device for a brushless motor, according to (G), wherein the energization mode of energizing the other two phases energizes the other two phases in response to a temperature of the medium. In this way, the viscosity of the medium fed with pressure by the electric pump can be estimated by the temperature of the medium, and the voltage energized to the other two phase can be changed in response to this temperature.

(I) The control device for a brushless motor, according to (G), wherein the energization mode of energizing the other two phases energizes the other two phases in response to a variation of a voltage generated in the non-energized phase. In this way, the viscosity of the medium fed with pressure by the electric pump can be estimated by the variation of the voltage generated in the non-energized phase, and the voltage energized to the other two phase can be changed in response to this variation.

(J) The control device for a brushless motor, according to any one of claims 1 to 3 and (A) to (I), wherein the energization mode of energizing the other two phases gradually decreases the voltage, which is energized to the other two phases, in response to an elapsed time from start of the energization to the other two phases by the positioning energization mode. In this way, a possibility that the swing of the rotor may rather become less likely to be attenuated due to the excessive functioning of the “brake” can be reduced.

(K) The control device for a brushless motor, according to any one of claims 1 to 3 and (A) to (I), wherein the energization mode of energizing the other two phases gradually decreases the voltage, which is energized to the other two phases, in response to amplitude of the non-energized phase voltage in the positioning energization mode. In this way, the possibility that the swing of the rotor may rather become less likely to be attenuated due to the excessive functioning of the “brake” can be reduced in a similar way to (J).

### REFERENCE SYMBOL LIST

100 Brushless motor
110u U-phase coil
110v V-phase coil
110w W-phase coil
120 Rotor
200 Motor control device
210 Drive circuit
220 Controller

1.-14. (canceled)

15. A control device for a brushless motor, the control device sequentially switching energization modes of energizing predetermined phases of stators, so as to rotate a rotor,
wherein, in a case of maintaining a predetermined energization mode and positioning the rotor to a predetermined position upon receiving a start command of the brushless motor, the predetermined energization mode is switched to either one of forward and backward energization modes based on a voltage generated in a non-energized phase.

16. The control device for a brushless motor, according to claim 15, wherein the forward and backward energization modes generate torque for the rotor in a direction reverse to a rotation direction, the rotor rotating by the predetermined energization mode.

17. The control device for a brushless motor, according to claim 15 wherein the predetermined energization mode is switched to either one of the forward and backward energization modes in response to a change of the voltage generated in the non-energized phase.

18. The control device for a brushless motor, according to claim 15, wherein, in a case in which the predetermined energization mode is switched to either one of the forward and backward energization modes based on the voltage generated in the non-energized phase, a time when the predetermined phases are energized next by the predetermined energization mode is at least after elapse of a predetermined time.

19. The control device for a brushless motor, according to claim 15, wherein the predetermined energization mode is switched to either one of the forward and backward energization modes in response to whether a variation of the voltage generated in the non-energized phase is positive or negative.

20. The control device for a brushless motor, according to claim 19, wherein, in a case in which the predetermined energization mode is switched to either one of the forward and backward energization modes, the either one of the forward and backward energization modes, to which the predetermined energization mode is switched, is switched again to the predetermined energization mode in response to whether the variation of the voltage generated in the non-energized phase is positive or negative.

21. The control device for a brushless motor, according to claim 15, wherein a variation of the voltage generated in the non-energized phase in a case of switching the predetermined energization mode to the either one of the forward and backward energization modes is inverted in polarity (positive/negative) with respect to a variation of a voltage generated in the non-energized phase in a case of switching the either one of the forward and backward energization modes to the predetermined energization mode.

22. The control device for a brushless motor, according to claim 15, wherein, in a case in which the brushless motor drives an electric pump, an energized voltage in the predetermined energization mode is a voltage at which the rotor can rotate in response to a temperature of a medium fed with pressure by the electric pump.

23. The control device for a brushless motor, according to claim 15, wherein, in a case in which the brushless motor drives an electric pump, an energized voltage in each of the forward and backward energization modes is changed in response to viscosity of the medium fed with pressure by the electric pump.

24. The control device for a brushless motor, according to claim 23, wherein the energized voltage in each of the forward and backward energization modes is changed in response to a temperature of the medium.

25. The control device for a brushless motor, according to claim 23, wherein the energized voltage in each of the forward and backward energization modes is changed in response to a variation of the voltage generated in the non-energized phase.

26. The control device for a brushless motor, according to claim 15, wherein an energized voltage in each of the forward and backward energization modes is gradually decreased in response to an elapsed time from start of the energization by the predetermined energization mode.

27. The control device for a brushless motor, according to claim 15, wherein an energized voltage in each of the forward and backward energization modes is gradually decreased in response to amplitude of the voltage of the non-energized phase in the predetermined energization mode.

28. A control method for a brushless motor, wherein a control unit for a brushless motor, the control unit sequentially switching energization modes of energizing predetermined phases of stators, so as to rotate a rotor,
wherein, in a case of maintaining a predetermined energization mode and positioning the rotor to a predetermined position upon receiving a start command of the brushless motor, the predetermined energization mode is switched to either one of forward and backward energization modes based on a voltage generated in a non-energized phase.
